(19) United States
(12) Patent Application Publication
(10) Pub. No.: US 2018/0001365 A1
(43) Pub. Date: Jan. 4, 2018

(54) SHEARING DEVICE OF EXTRUSION PRESS

(71) Applicant: Ube Machinery Corporation, Ltd., Ube-shi (JP)

(72) Inventors: Takeharu Yamamoto, Ube-shi (JP); Masahiro Doki, Ube-shi (JP)

(21) Appl. No.: 15/543,340

(22) PCT Filed: Jun. 30, 2015
(86) PCT No.: PCT/JP2015/068851

§ 371 Date: Jul. 13, 2017

(30) Foreign Application Priority Data
Jan. 22, 2015 (JP) 2015-009939

(51) Int. Cl. B21C 35/04; B23D 15/04

(52) U.S. Cl. CPC B21C 35/04; B23D 15/04

(57) ABSTRACT

A shearing device of an extrusion press for cutting off a discard includes a first drive device; a means for converting rotational motion generated by the first drive device to linear motion; a shearing-slide drive frame caused to move linearly by the means for converting rotational motion to linear motion, which shearing-slide drive frame is coupled to a shearing slide to which a shearing blade is fixed; a slide part coupled with the shearing-slide drive frame through a link unit; and a second drive device causing the slide part move linearly to cause the shearing-slide drive frame move linearly, wherein the first drive device and the second drive device are arranged in parallel with the means for converting rotational motion to linear motion.

### TECHNICAL FIELD

The present invention relates to a shearing device in an extrusion press for extruding an aluminum alloy or other metal in which the shearing device makes a container separate from a die after extrusion and cuts off a remainder of a billet, that is, a discard, at a front surface of the die to thereby cut it off from an extruded product part.

### BACKGROUND ART

In a conventional shearing device of an extrusion press, a shearing cylinder for cutting off the discard is attached facing downward to a frame provided at a container side of a top part of an end platen holding the die and a shearing blade is provided through a shearing slide at the bottom end part of a piston rod of the shearing cylinder.

In a conventional extrusion press, an electric powered shearing device used a single long ball screw for a drive device and further had a motor for driving the ball screw arranged at a top side of the ball screw. For this reason, the shearing device as a whole became higher in height and it is necessary to raise the height of the building etc. Furthermore, in an extrusion press with a drive device comprised of a hydraulic cylinder, the hydraulic cylinder is attached on top of the shearing slide with the shearing blade, the shearing guide, and the shearing frame. If including the length of the cylinder rod, the height became considerable.

### CITATION LIST

### Patent Literature

PLT 1: Japanese Patent Application Publication No. 2013-244509A

### SUMMARY OF INVENTION

### Technical Problem

In a conventional type of extrusion press, there are the following problems.

In a conventional type of extrusion press, an electric powered shearing device used a single long ball screw for a driving means and further had a motor for driving a ball screw arranged at the top side of the ball screw.

Further, a hydraulic cylinder is used for a drive device, so the shearing device as a whole became higher in height and the height of the building etc. had to be raised.

### Solution to Problem

According to the present invention, there is provided a shearing device of an extrusion press for cutting off a discard, the shearing device of an extrusion press comprising a first drive device, a means for converting rotational motion generated by the first drive device to linear motion, a shearing-slide drive frame made to move linearly by the means for converting rotational motion to linear motion, which shearing-slide drive frame is coupled to a shearing slide to which a shearing blade is fixed, a slide part coupled with the shearing-slide drive frame through a link unit, and a second drive device making the slide part move linearly to make the shearing-slide drive frame move linearly, the first drive device and the second drive device being arranged in parallel with the means for converting rotational motion to linear motion,

In the present invention, the second drive device may be comprised of a motor, and the shearing device of the extrusion press may further comprise a second means for converting rotational motion generated by the motor to linear motion.

In the present invention, the second drive device may be comprised of a hydraulic cylinder.

In the present invention, power causing descending motion of the shearing slide before cutting the discard may be generated by the first drive device, a large part of power causing descending motion of the shearing slide cutting the discard by the shearing blade may be generated by the second drive device, and power causing ascending motion of the shearing slide after cutting off the discard by the shearing blade may be generated by the first and second drive devices.

In the present invention, the hydraulic cylinder may be operated by a fire-resistant hydraulic fluid.

### Advantageous Effects of Invention

Compared with a conventional shearing device, the stroke of the shearing blade is the same, but by dividing a drive device into two (first and second) devices, and by arranging the drive devices in parallel, it is possible to greatly lower the height of the device, so the building can be lowered.

### BRIEF DESCRIPTION OF DRAWINGS

FIG. 1A is a front view of a shearing device of a first embodiment of the present invention.

FIG. 1B is a side view of the shearing device shown in FIG. 1A.

FIG. 1C is a plan view of the shearing device shown in FIG. 1A.

FIG. 2 are views of operation of the shearing device of the first embodiment of the present invention by front views.

FIG. 3 are views of operation of a shearing device of a second embodiment of the present invention by front views.

### DESCRIPTION OF EMBODIMENTS

Embodiments of the shearing device according to the present invention will be explained in detail below while referring to the drawings.

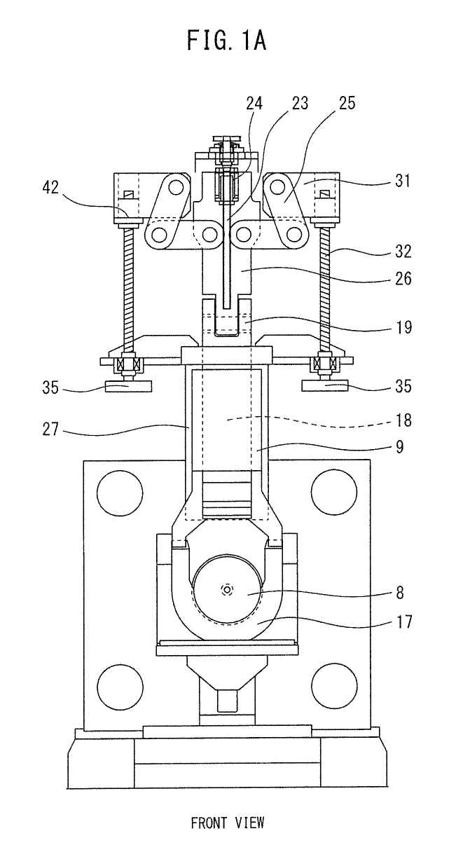

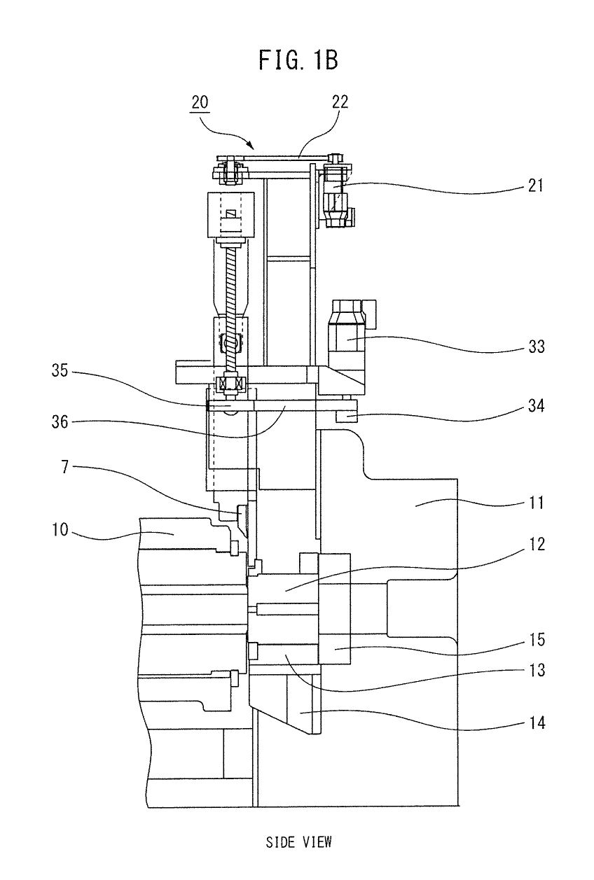

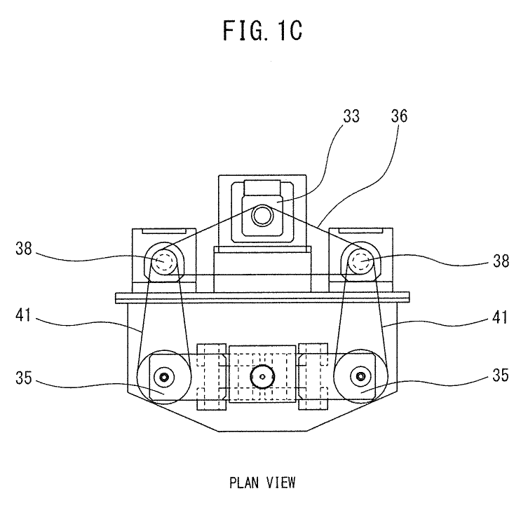

FIGS. 1A, 1B, and 1C, FIG. 2, and FIG. 3 will be used to explain embodiments of the present invention. In FIGS. 1A, 1B, and 1C, reference notation 11 indicates an end platen, 12 a die stack, 13 a die block, 14 a guide member for guiding movement in a horizontal direction perpendicular to a back surface of the die block 13, and 15 is a pressure ring inside the end platen receiving pressing force from the die stack 12. At the center parts of the pressure ring 15 and end platen 11, a hole is provided for passage of a product extruded from the die stack 12. Note that, the die stack 12 is comprised of a not shown plurality of parts.

At the top container side of the end platen 11 holding the die stack 12 at its front surface side, a shearing frame 27 is attached. At part of the shearing frame 27, a shaft 19 is used to attach a shearing slide 18 housed inside of a shearing guide 9 to be able to rotate in extrusion and anti-extrusion directions. Reference notation 7 is a shearing blade for cutting off a discard. Reference notation 18 is the shearing slide. The shearing blade 7 is attached to the shearing slide 18. Between the shearing blade 7 and the shearing slide 18, there is a not shown shim for adjusting the clearance between the cutting surface of the die stack 12 and the shearing blade 7. Further, reference notation 10 is a container in which a billet is inserted.

The die stack 12 is housed in a die block 13. A die set comprised of the die stack 12 and die block 13 is pushed in the direction of the end platen, so that the movement in the horizontal direction of the die set is restricted between a pressure ring 15 and horseshoe 17. By this configuration, the die stack 12 is fastened to the end platen 11 by a die stack horizontal fastening cylinder through a not shown horizontal direction arm.

Simultaneously, a not shown vertical die clamp may be used to push the die stack 12 and fasten it in the vertical direction as well. The vertical die clamp operates by a die stack vertical fastening cylinder.

Referring to FIGS. 1A and 1B, the surface of the bottom end of the shearing guide 9 at the die stack side pushes against the container side end face of the horseshoe 17 by a not shown swing cylinder for the shearing slide.

By fastening in this way, the relative position of the horseshoe 17 and the shear face side of the die stack 12 can be maintained constant at all times. Even if in the middle of cutting off the discard after extrusion, due to this pressing action in the horizontal direction and pressing action in the vertical direction, the die stack 12 can be maintained at the same position at all times without moving.

The shearing slide 18 is housed inside the shearing guide 9. By a not shown shearing-slide swinging cylinder swinging about a not shown pin, the shearing guide 9 swings about the pin. By being driven by the motor, the shearing slide 18 slides up and down inside the shearing guide 9. Due to this, the shearing blade 7 is made suitable in distance from the die stack 12.

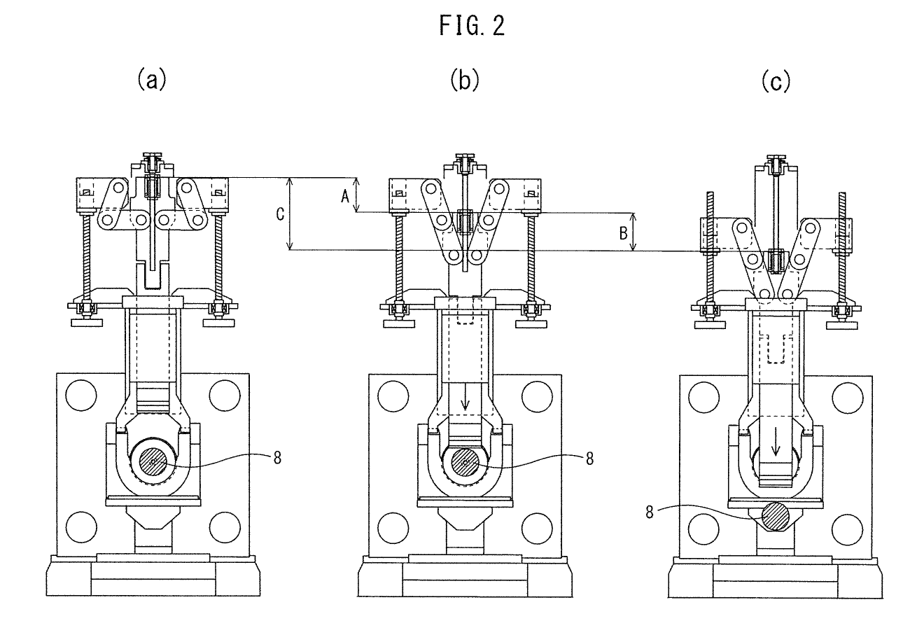

The first embodiment will be further explained with reference to FIGS. 1A, 1B, and 1C and FIG. 2.

First, the stroke of the shearing blade 7 of the shearing device of the present invention, as will be understood from FIG. 2, includes the two strokes of a first stroke of the shearing blade 7 attached to the shearing slide 18 descending until contacting the discard (in FIG. 2, range of reference notation A) and a second stroke of cutting off the discard (in FIG. 2, range of reference notation B). In the first stroke, the first drive device is operated, while in the second stroke, the first and second drive devices are simultaneously operated. In the present embodiment, the first drive device is configured by a first motor 21, while the second drive device is configured from a second motor 33.

In the first stroke, the first motor 21 attached to the shearing frame 27 is operated. An output shaft of the first motor 21 and an end part of a ball screw 23 are connected by a timing belt. The first motor 21, for example, may be a servo motor or such. If the first motor 21 is used to make the ball screw 23 turn, a shearing-slide drive frame 26 formed integrally with a ball nut 24 descends.

One end of the shearing-slide drive frame 26 is coupled with the shearing slide 18 by a pin 19 and simultaneously coupled at the other end with the one end of each of link units 25. Furthermore, the other end of each of the link units 25 is coupled with the slide part 31. In the present embodiment, a converting means for converting rotational motion to linear motion is explained as the ball screw 23 and ball nut 24, but may also be a rack and pinion or such.

At the time of start of the shearing operation, the link units 25 are folded up in state (FIG. 2(a)). If the shearing-slide drive frame 26 starts to descend, the link units 25 open. As shown in FIG. 2(b), if the shearing-slide drive frame 26 descends until the link units 25 become the substantially straight state, the shearing-slide drive frame 26 is configured to fall in speed.

In the second stroke, the second motor 33 attached to the shearing frame 27 while facing vertically downward is driven. The second motor 33 may, for example, be a servo motor or such as well. Further, the method of attachment is not limited to facing vertically downward. A first pulley 34 of the output shaft of the second motor 33 and two second pulleys 38 are connected by a belt 36. The two second pulleys 38 and two third pulleys 35 of the two ball screws 32 are respectively connected by belts 41. The belts may, for example, be timing belts or such. By such a configuration, the servo motor comprising the second motor 33 can drive the two ball screws 32 synchronized. Note that, the ball screws 32 and the ball nuts 42 combined with these act as second converting means for converting rotational motion to linear motion.

Due to the drive operation of the second motor 33, the two ball screws 32 turn and the slide part 31 connected with the ball nuts 42 is made to descend. FIG. 2(b) shows the state when the shearing blade 7 has just contacted the discard 8. If operating the second motor 33 to make the slide part 31 descend from this state, force is transmitted to the discard from the slide part 31 through the two link units 25, shearing slide 18, and shearing blade 7. If further making the slide part 31 descend and reaching the state of FIG. 2(c), the discard 8 is cut off.

Further, the first motor 21 driving operation in the first stroke continues to drive operation in the second stroke as well and simultaneously the second motor 33 drives operation to track the second stroke. In the present embodiment, the power generated by second motor 33 is far larger than the power generated by the first motor 21. Therefore, the majority of the power required for the second stroke is supplied from the second motor 33. After the discard finishes being cut off, to make the shearing slide 18 etc. return to their initial positions at a high speed, the first and second drive motors 21 and 33 are simultaneously driven in opposite directions to the time of descent.

The first stroke shown by reference notation A in FIG. 2 is a stroke where no load is applied to the shearing blade 7 and where the shearing blade 7 can move at a high speed by a low output, while the second stroke shown by reference notation B is a stroke where a load is applied to a shearing blade 7 and where the shearing blade 7 can move at a low speed by a high output. The entire stroke is C=A+B.

Breakage or slack of the belt 36 and belt 41 are detected by not shown proximity sensors or are detected by the load current of the second motor 33. If the belt 36 and belt 41 breaks or becomes slack, not shown electromagnetic brakes attached to the end faces of the ball screws are operated so as to be able to prevent in advance a drop in the slide part 31 downward.

The electromagnetic brake operates electrically. When electric power is turned on, it opens, while when electric power is cut off, the brake is applied.

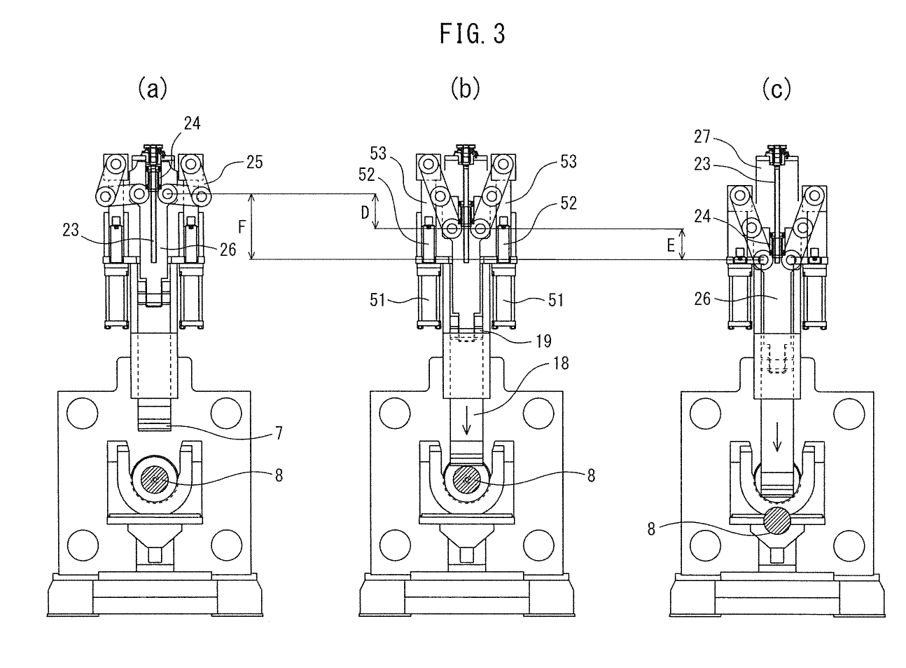

A second embodiment will be explained with reference to FIG. 3. In the second embodiment, the first drive device is configured by a motor 21 (not shown), while the second drive device is configured by hydraulic cylinders 51. In the first stroke, the motor 21 attached to the shearing frame 27 is operated. The output shaft of the motor 21 and the end part of the ball screw 23 are connected by a belt. The motor 21 may be, for example, a servo motor. If the motor 21 is used to make the ball screw 23 turn, the shearing-slide drive frame 26 formed integrally with the ball nut 24 descends. Note that, in FIG. 3, the motor 21 is not shown, but the motor 21 is arranged in the same way as the first motor 21 in the first embodiment shown in FIG. 1(b).

One end of the shearing-slide drive frame 26 is coupled by the pin 19 with the shearing slide 18 and, simultaneously, the other end is coupled with one end of each of link units 25. Furthermore, the other end of each of the link units 25 is coupled with a slide part 53.

At the point of time of the start of a shearing operation, the link units 25 are folded up in state (FIG. 3(a)). If the shearing-slide drive frame 26 starts to descend, the link units 25 open. As shown in FIG. 3(b), if the shearing-slide drive frame 26 descends until the link units 25 become the substantially straight state, the shearing-slide drive frame 26 is configured to fall in speed.

In the second stroke, the two hydraulic cylinders 51 make the slide parts 53 descend. FIG. 3(b) shows the state where the shearing blade 7 just contacts the discard 8. If driving the hydraulic cylinders 51 to make the slide parts 53 descend from this state, force is applied to the discard from the slide parts 53 through the two link units, shearing slide 18, and shearing blade 7. If the slide parts 53 are made to further descend to the state of FIG. 3(c), the discard 8 is cut off.

The motor 21 is operated even during the second stroke so as to track the shearing-slide drive frame 26.

For the two slide parts 53, a not shown pipe-shaped guide may be provided.

For the hydraulic fluid of the hydraulic cylinders 51, in the present embodiment, for example, a fire-resistant hydraulic fluid such as a water-glycol fluid is used.

The first stroke shown by the reference notation D in FIG. 3 is a stroke in which the shearing blade 7 can move at a high speed by a low output in the stroke of a load being not applied to the shearing blade 7, while the second stroke shown by the reference notation E is a stroke in which the shearing blade 7 can move at a low speed by a high output in the stroke of a load being applied to the shearing blade 7. The strokes are F=D+E.

After cutting off the discard, the shearing slide 18 etc. are made to return to their initial positions at a high speed by making both the drive motor 21 and hydraulic cylinders 51 operate in the opposite direction to the time of descent.

The present invention has the following effects due to being configured in the above way.

Compared with a conventional shearing device, the stroke of the shearing blade is the same, but two (first and second) drive devices are provided and arranged at the side of the ball screw 23 or shearing-slide drive frame 26, that is, in parallel with the ball screw 23 or shearing-slide drive frame 26, so as to greatly lower the height of the device, so the building can be lowered.

In the second embodiment, the hydraulic fluid of the hydraulic cylinder is a fire-resistant hydraulic fluid such as a water-glycol fluid, so even if the fluid leaks, it is possible to lighten the risk of fire at the time of operation or maintenance.

Further, even if, like in second embodiment, using hydraulic cylinders for the second drive device, this is used only when cutting off the discard, so the amount of hydraulic fluid can be greatly cut and resource saving and energy saving can be contributed to.

### REFERENCE SIGNS LIST

7. shearing blade
8. discard
9. shearing guide
11. end platen
12. die stack
13. die block
14. guide member
17. horseshoe
18. shearing slide
20. shearing device
21. first motor
22. belt
23. ball screw
24. ball nut
25. link unit
26. shearing-slide drive frame
27. shearing frame
31. slide part
32. ball screw
33. second motor
34. first pulley
35. third pulley
36. belt
38. second pulley
41. belt
42. ball nut
51. hydraulic cylinder
52. cylinder rod
53. slide part

1. A shearing device of an extrusion press for cutting off a discard comprising:
a first drive device;
a means for converting rotational motion generated by the first drive device to linear motion;
a shearing-slide drive frame caused to move linearly by the means for converting rotational motion to linear motion, which shearing-slide drive frame is coupled to a shearing slide to which a shearing blade is fixed;
a slide part coupled with the shearing-slide drive frame through a link unit; and
a second drive device causing the slide part move linearly to cause the shearing-slide drive frame move linearly,
wherein the first drive device and the second drive device are arranged in parallel with the means for converting rotational motion to linear motion.

2. The shearing device of an extrusion press according to claim 1, wherein
the second drive device is comprised of a motor, and
the shearing device further comprises a second means for converting rotational motion generated by the motor to linear motion.

3. The shearing device of an extrusion press according to claim 1, wherein the second drive device comprises a hydraulic cylinder.

4. The shearing device of an extrusion press according to claim 1, wherein
power causing a descending motion of the shearing slide before cutting the discard is generated by the first drive device,
a large part of the power causing the descending motion of the shearing slide cutting the discard by the shearing blade is generated by the second drive device, and
power causing an ascending motion of the shearing slide after cutting off the discard by the shearing blade is generated by the first and second drive devices.

5. The shearing device of an extrusion press according to claim 3, wherein the hydraulic cylinder is operated by a fire-resistant hydraulic fluid.
